(19) United States
(12) Patent Application Publication
(10) Pub. No.: US 2026/0058401 A1
(43) Pub. Date: Feb. 26, 2026

(54) COVER UNIT AND CONNECTOR

(71) Applicant: SUMITOMO WIRING SYSTEMS, LTD., Mie (JP)

(72) Inventor: Chiharu OGURA, Mie (JP)

(21) Appl. No.: 19/304,970

(22) Filed: Aug. 20, 2025

(30) Foreign Application Priority Data
Aug. 22, 2024 (JP) 2024-140890

(51) Int. Cl. H01R 13/502

(52) U.S. Cl. CPC H01R 13/502; H01R 2201/26

(57) ABSTRACT

A cover unit includes a columnar rubber plug press-fittable into a communication hole of a connector housing, and a plate-like cover including a fixing hole and fixable to the connector housing. The rubber plug includes a rubber plug body portion, a first large-diameter portion for contacting a first principal surface of the cover in an assembled state where the rubber plug is assembled in the fixing hole, a fixing shaft portion to be fit in the fixing hole in the assembled state, a second large-diameter portion projecting in a direction intersecting a press-fit axis while being sized to be passable through the fixing hole by being resiliently deformed, the cover being sandwiched along the press-fit axis by the first large-diameter portion and the second large-diameter portion in the assembled state.

### CROSS-REFERENCE TO RELATED APPLICATIONS

This application is based on and claims priority from Japanese Patent Application No. 2024-140890, filed on Aug. 22, 2024, with the Japan Patent Office, the disclosure of which is incorporated herein in its entirety by reference.

### TECHNICAL FIELD

The present disclosure relates to a cover unit and a connector.

### BACKGROUND

Conventionally, voltage detection from outside through a communication hole is possible for some connectors (see, for example, Japanese Patent Laid-open Publication No. 2016-225055). This connector is provided with a connector housing including the communication hole and a terminal fitting accommodated inside the connector housing, and voltage detection from outside is possible by bringing a probe of a voltage detector into contact with the terminal fitting through the communication hole. Further, this connector is provided with a cover unit. The cover unit is provided with a rubber plug press-fittable into the communication hole, a plate-like cover including a fixing hole for fixing the rubber plug and a rubber plug holder to be fit into the fixing hole of the cover while having the rubber plug mounted therein. The cover unit is configured such that the cover is fixed to the connector housing and the rubber plug is press-fit into the communication hole. Voltage detection from outside through the communication hole is possible for the connector by removing the cover unit from the connector housing.

### SUMMARY

However, in the connector as described above, the cover unit required the rubber plug holder. Further, assemblability in mounting the rubber plug into the rubber plug holder was poor. Specifically, an operation of mounting the rubber plug into the rubber plug holder is complicated and, for example, an assembly operation needed to be manually performed.

The present disclosure aims to provide a cover unit and a connector enabling configuration simplification and an improvement in assemblability.

The present disclosure is directed to a cover unit with a columnar rubber plug press-fittable into a communication hole of a connector housing along a press-fit axis, and a plate-like cover including a fixing hole for fixing the rubber plug, the cover being fixable to the connector housing, the rubber plug including a rubber plug body portion press-fittable into the communication hole with a tip part in the lead, a first large-diameter portion provided on a base end part of the rubber plug body portion, the first large-diameter portion projecting in a direction intersecting the press-fit axis, the first large-diameter portion contacting a first principal surface of the cover in an assembled state where the rubber plug is assembled in the fixing hole, a fixing shaft portion extending in a direction opposite to the rubber plug body portion from the first large-diameter portion, the fixing shaft portion being fit in the fixing hole in the assembled state, a second large-diameter portion provided on a tip part of the fixing shaft portion, the second large-diameter portion projecting in a direction intersecting the press-fit axis while being sized to be passable through the fixing hole by being resiliently deformed, the cover being sandwiched along the press-fit axis by the first large-diameter portion and the second large-diameter portion in the assembled state, and a temporary holding shaft portion extending in a direction opposite to the fixing shaft portion from the second large-diameter portion, the temporary holding shaft portion being capable of temporarily holding the rubber plug so that the rubber plug is not tilted with respect to the cover in a temporarily assembled state where the temporary holding shaft portion is fit in the fixing hole.

According to the cover unit and a connector of the present disclosure, configurations can be simplified and assemblability can be improved.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a connector in one embodiment.

FIG. 2 is an exploded perspective view of the connector in the embodiment.

FIG. 3 is a section of the connector in the embodiment.

FIG. 4 is a partial section showing a manufacturing process of a cover unit in the embodiment.

FIG. 5 is a partial section showing the manufacturing process of the cover unit in the embodiment.

FIG. 6 is a partial section showing the manufacturing process of the cover unit in the embodiment.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of Present Disclosure

First, embodiments of the present disclosure are listed and described.
[1] The cover unit of the present disclosure is provided with a columnar rubber plug press-fittable into a communication hole of a connector housing along a press-fit axis, and a plate-like cover including a fixing hole for fixing the rubber plug, the cover being fixable to the connector housing, the rubber plug including a rubber plug body portion press-fittable into the communication hole with a tip part in the lead, a first large-diameter portion provided on a base end part of the rubber plug body portion, the first large-diameter portion projecting in a direction intersecting the press-fit axis, the first large-diameter portion contacting a first principal surface of the cover in an assembled state where the rubber plug is assembled in the fixing hole, a fixing shaft portion extending in a direction opposite to the rubber plug body portion from the first large-diameter portion, the fixing shaft portion being fit in the fixing hole in the assembled state, a second large-diameter portion provided on a tip part of the fixing shaft portion, the second large-diameter portion projecting in a direction intersecting the press-fit axis while being sized to be passable through the fixing hole by being resiliently deformed, the cover being sandwiched along the press-fit axis by the first large-diameter portion and the second large-diameter portion in the assembled state, and a temporary holding shaft portion extending in a direction opposite to the fixing shaft portion from the second large-diameter portion, the temporary holding shaft portion being capable of temporarily holding the rubber plug so that the rubber plug is not tilted with respect to the cover in a temporarily assembled state where the temporary holding shaft portion is fit in the fixing hole.

According to this configuration, the rubber plug is fixed to the cover by the fixing shaft portion being fit into the fixing hole and sandwiching the cover by the first and second large-diameter portions if the second large-diameter portion is passed through the fixing hole. Thus, the configuration can be, for example, simpler than a configuration provided with a separate rubber plug holder for fixing the rubber plug to the cover. Further, since the rubber plug includes the temporary holding shaft portion extending in the direction opposite to the fixing shaft portion from the second large-diameter portion and can temporarily hold the rubber plug so that the rubber plug is not tilted with respect to the cover in the temporarily assembled state where the temporary holding shaft portion is fit in the fixing hole, assemblability with the cover is improved. For example, the rubber plug can be easily assembled with the cover by a first automatic machine for arranging the rubber plug to fit the temporary holding shaft portion into the fixing hole and a second automatic machine for assembling the rubber plug by pushing the rubber plug from the temporarily assembled state where the temporary holding shaft portion is fit in the fixing hole.
[2] In [1] described above, the fixing hole may include a hole diameter enlarged portion having a diameter gradually increased toward the first principal surface, and the second large-diameter portion may include an inclined portion inclined to be held in surface contact with the hole diameter enlarged portion in the temporarily assembled state.

According to this configuration, since the fixing hole includes the hole diameter enlarged portion having a diameter gradually increased toward the first principal surface, the temporary holding shaft portion of the rubber plug is easily fit. Since the second large-diameter portion includes the inclined portion inclined to be held in surface contact with the hole diameter enlarged portion of the fixing hole in the temporarily assembled state where the temporary holding shaft portion is fit in the fixing hole, the rubber plug is less likely to be tilted with respect to the cover in the temporarily assembled state. Therefore, the assemblability of the rubber plug with the cover is more improved.
[3] In [1] or [2] described above, the base end part of the rubber plug body portion may include a body diameter enlarged portion having a diameter gradually increased toward the first large-diameter portion.

According to this configuration, since the base end part of the rubber plug body portion includes the body diameter enlarged portion having a diameter gradually increased toward the first large-diameter portion, it can be suppressed that the rubber plug is bent, for example, when the rubber plug is pushed from the temporarily assembled state where the temporary holding shaft portion is fit in the fixing hole.
[4] In any one of [1] to [3] described above, the rubber plug body portion may include a body shaft portion and a lip portion pressable into contact with the communication hole by projecting radially outward from the body shaft portion, and a diameter of the temporary holding shaft portion may be set to be equal to or larger than that of the body shaft portion.

According to this configuration, since the diameter of the temporary holding shaft portion is set to be equal to or larger than that of the body shaft portion of the rubber plug body portion, the rubber plug is less likely to be tilted with respect to the cover in the temporarily assembled state, for example, as compared to the case where the diameter of the temporary holding shaft portion is set to be smaller than that of the body shaft portion.
[5] In any one of [1] to [4] described above, the rubber plug may be a solid body.

According to this configuration, since the rubber plug is a solid body, it can be suppressed that the rubber plug is bent, for example, when the rubber plug is pushed from the temporarily assembled state where the temporary holding shaft portion is fit in the fixing hole. That is, if the rubber plug is, for example, configured to have a gap inside, the rubber plug is easily bent when the rubber plug is pushed from the temporarily assembled state where the temporary holding shaft portion is fit in the fixing hole. However, if the rubber plug is a solid body, this can be suppressed.
[6] A connector of the present disclosure is provided with the cover unit of any one of [1] to [5] described above, the connector housing and a terminal fitting accommodated inside the connector housing, voltage detection from outside through the communication hole being enabled for the terminal fitting.

According to this configuration, in the connector enabling voltage detection from outside through the communication hole, the configuration of the cover unit can be simplified and the assemblability of the rubber plug with the cover is improved.

### Details of Embodiment of Present Disclosure

A specific example of a connector of the present disclosure is described below with reference to the drawings. For the convenience of description, some components may be shown in an exaggerated or simplified manner in each drawing. Further, a dimension ratio of each part may be different in each figure.

A term “tubular” used in the description of this specification indicates not only a shape formed by a peripheral wall continuous over an entire periphery in a circumferential direction, but also a tubular shape formed by combining a plurality of components and a shape having a cut or the like in a circumferential part such as a C shape. “Tubular” outer peripheral shapes include circular shapes, elliptical shapes and polygonal shapes with angular or round corners, but there is no limitation to these. “Tubular” shapes are shapes including a through hole in a plan view, and include shapes in which an outer peripheral shape and an inner peripheral shape of a through hole are the same and shapes in which an outer peripheral shape and an inner peripheral shape of a through hole are different. The “tubular” shapes include those having a predetermined length extending along an axial direction, in which a center axis passing through a center of a through hole extends, and the lengths thereof do not matter. “Facing each other” in this specification indicates that surfaces or members are at positions in front of each other, and means not only a case where the surfaces or members are at positions perfectly in front of each other, but also a case where the surfaces or members are at positions partially in front of each other. Further, “facing each other” in this specification means both a case where another member different from two parts is interposed between the two parts and a case where nothing is interposed between the two parts. Further, terms such as “first”, “second” and “third” in this specification are merely used to distinguish objects and do not rank the objects. The present invention is not limited to these illustrations, but is represented by claims and intended to include all changes in the scope of claims and in the meaning and scope of equivalents.

### (Configuration of Connector 10)

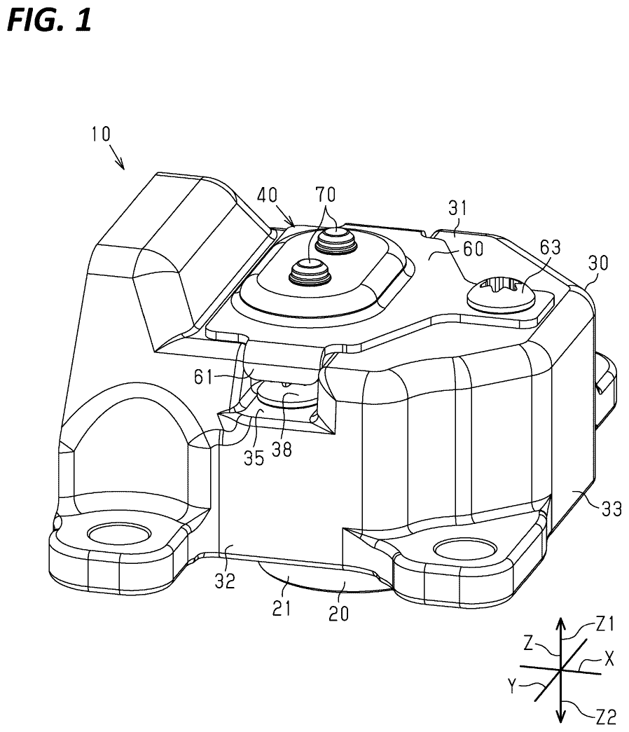

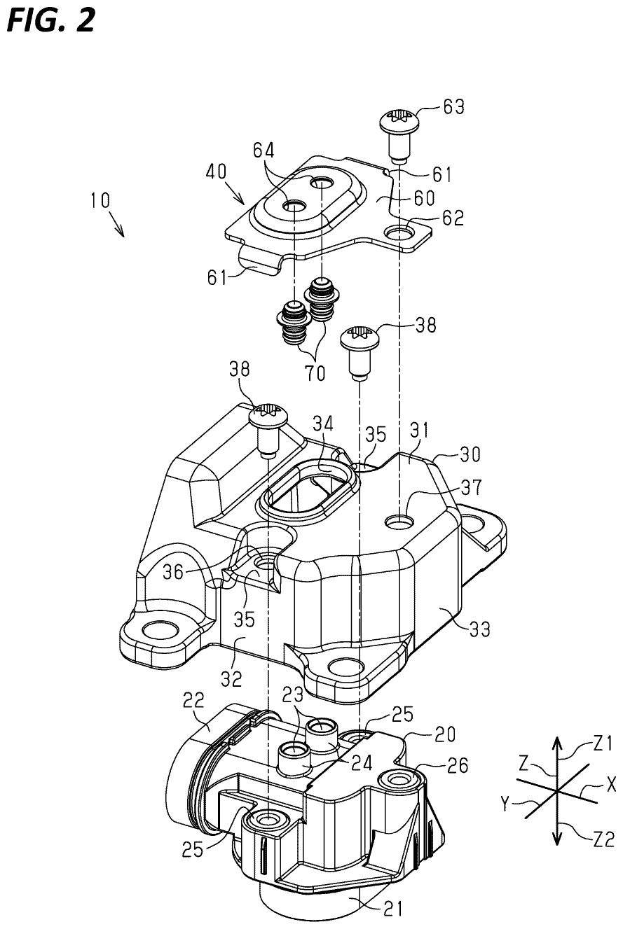

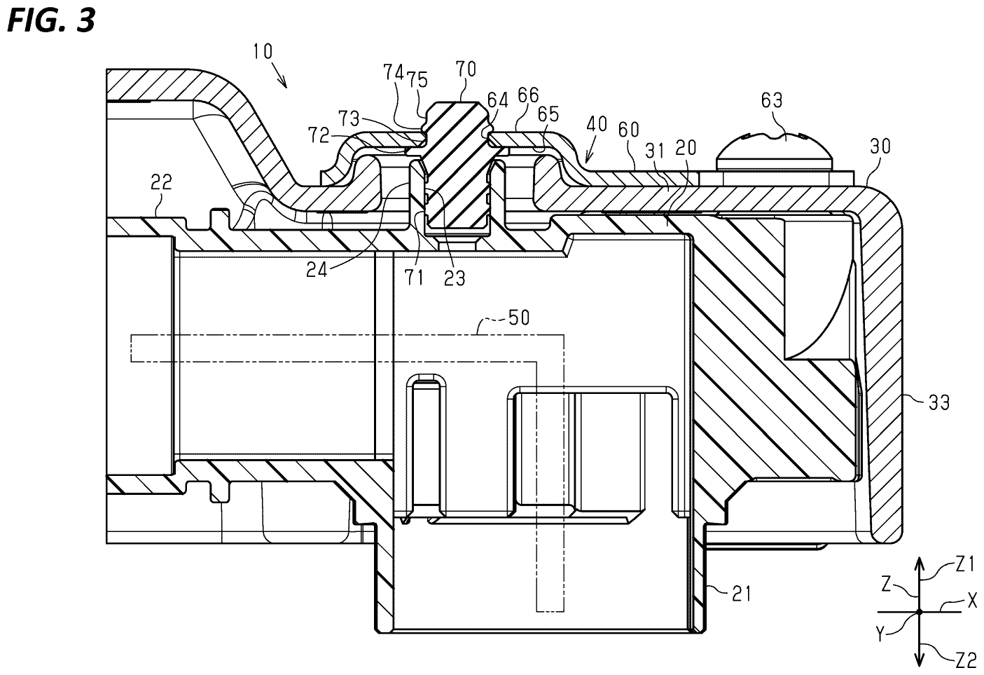

As shown in FIGS. 1 and 2, a connector 10 is provided with a connector housing 20, a metal shell 30 and a cover unit 40. Further, as shown in FIG. 3, the connector 10 is provided with terminal fittings 50. The connector 10 is, for example, provided in an unillustrated vehicle such as a hybrid vehicle or an electric vehicle. Specifically, the connector 10 is mounted on a case of an in-vehicle device such as an inverter provided in the vehicle and a large current flows therein.

In each figure, a first axis X1, a second axis Y orthogonal to the first axis X and a third axis Z serving as a press-fit axis orthogonal to the first and second axes X, Y are shown. Further, in the figures, an upward direction Z1, which is one direction along the third axis Z, and a downward direction Z2, which is a direction opposite to the upward direction Z1, are shown.

### (Configuration of Connector Housing 20)

The connector housing 20 is made of a resin material.

As shown in FIGS. 2 and 3, the connector housing 20 includes a first tubular portion 21 extending in the upward direction Z1 along the third axis Z and a second tubular portion 22 extending along the first axis X while being bent from the upper end of the first tubular portion 21. Further, the connector housing 20 includes communication holes 23 allowing communication between the inside and outside of the connector housing 20 by penetrating along the third axis Z. The communication holes 23 of this embodiment are formed by the inner surfaces of tube portions 24 projecting in the upward direction Z1 from the connector housing 20. As shown in FIG. 2, in this embodiment, two communication holes 23 and two tube portions 24 are provided side by side along the second axis Y. Further, as shown in FIG. 3, the terminal fittings 50 are accommodated and held inside the connector housing 20. The terminal fittings 50 are arranged at positions where voltage detection from outside through the communication holes 23 is possible. That is, the terminal fittings 50 are arranged to pass below the communication holes 23 in the downward direction Z2. Note that although the terminal fitting 50 is schematically shown as one L-shaped member in FIG. 3, there is no limitation to this. Of course, the terminal fitting 50 may be configured by combining two or more metal members.

Further, as shown in FIG. 2, two first nuts 25 are embedded in the connector housing 20. The first nuts 25 are arranged in both side parts of the connector housing 20. The first nut 25 is formed into a tubular shape and includes an internally threaded groove open in the upward direction Z1 of the connector housing 20.

Further, one second nut 26 is embedded in the connector housing 20. The second nut 26 is arranged in a rear end part of the connector housing 20. Similarly to the first nuts 25, the second nut 26 is formed into a tubular shape and includes an internally threaded groove open in the upward direction Z1 of the connector housing 20.

### (Configuration of Metal Shell 30)

The metal shell 30 includes an upper wall 31 for covering the upper surface of the connector housing 20, side walls 32 for covering both side surfaces of the connector housing 20 and a rear wall 33 for covering the rear end surface of the connector housing 20. The upper wall 31 includes an exposure hole 34 for exposing the tube portions 24 of the connector housing 20 in the upward direction Z1. The exposure hole 34 of this embodiment is formed into an oval hole having a range including the two tube portions 24 when viewed from the upward direction Z1. Further, the upper wall 31 includes recesses 35 at positions corresponding to the first nuts 25 and includes first through holes 36 in bottom parts of the recesses 35. Further, the upper wall 31 includes a second through hole 37 at a position corresponding to the second nut 26.

The metal shell 30 is fixed to the connector housing 20 by first screws 38 passed through the first through holes 36 and threadably engaged with the first nuts 25. The metal shell 30 suppresses the emission of electromagnetic noise from the connector 10 to outside when large currents flow in the terminal fittings 50 (see FIG. 3).

### (Configuration of Cover Unit 40)

As shown in FIGS. 1 to 3, the cover unit 40 is provided with a cover 60 fixable to the connector housing 20 and two rubber plugs 70 to be assembled with the cover 60.

### (Configuration of Cover 60)

The cover 60 is made of a metal plate.

As shown in FIG. 2, the cover 60 includes a pair of bent pieces 61 engageable with the inner side surfaces of the recesses 35 of the metal shell 30. Further, the cover 60 includes a cover through hole 62 at a position corresponding to the second through hole 37. The cover 60 is fixed to the connector housing 20 and the metal shell 30 by a second screw 63 passed through the cover through hole 62 and the second through hole 37 and threadably engaged with the second nut 26 with the bent pieces 61 engaged with the inner side surfaces of the recesses 35.

Further, the cover 60 includes fixing holes 64 for fixing the rubber plugs 70 at positions corresponding to the communication holes 23 of the connector housing 20. In this embodiment, two fixing holes 64 are provided at positions respectively corresponding to the two communication holes 23.

As shown in FIG. 3, the fixing hole 64 penetrates from a first principal surface 65, which is a surface facing the upper wall 31 of the metal shell 30 on a lower side Z2, to a second principal surface 66, which is a surface opposite to the first principal surface 65 and located on an upper side Z1.

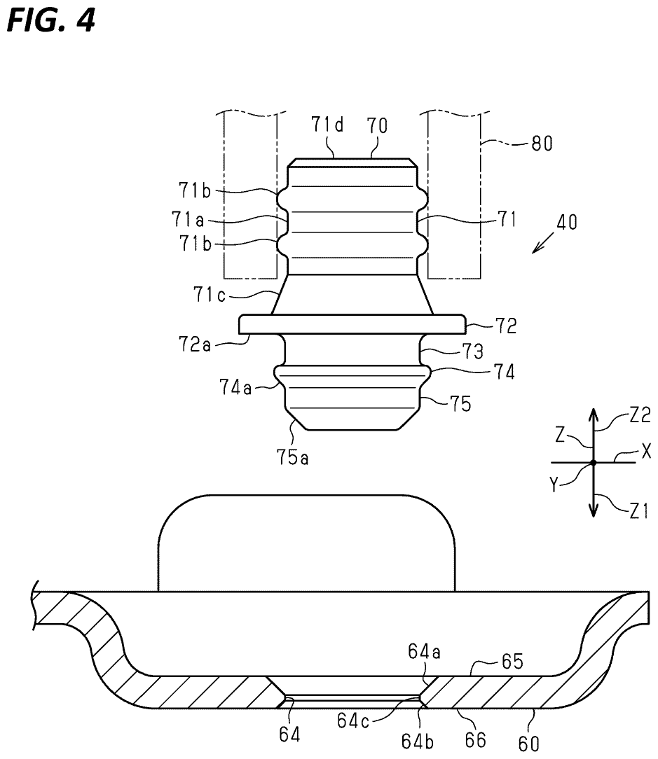

As shown in FIG. 4, the fixing hole 64 includes a hole diameter enlarged portion 64a having a diameter gradually increased toward the first principal surface 65 in a part leading to the first principal surface 65. Further, the fixing hole 64 includes a chamfered portion 64b having a diameter gradually increased toward the second principal surface 66 in a part leading to the second principal surface 66. Further, the fixing hole 64 includes a constant diameter portion 64c having a constant diameter between the hole diameter enlarged portion 64a and the chamfered portion 64b. Further, in this embodiment, a maximum diameter of the hole diameter enlarged portion 64a is set to be larger than that of the chamfered portion 64b. Further, in this embodiment, a length of the hole diameter enlarged portion 64a along the third axis Z is set to be longer than that of the chamfered portion 64b along the third axis Z. Note that FIGS. 4 to 6 are views showing a manufacturing process of the cover unit 40, and show the directions along the third axis Z, i.e. the upward direction Z1 and the downward direction Z2, to be opposite to those in FIGS. 1 to 3.

### (Configuration of Rubber Plugs 70)

As shown in FIG. 3, the rubber plug 70 can be press-fit into the communication hole 23 of the connector housing 20 along the third axis Z serving as the press-fit axis. In particular, the rubber plug 70 is made of a columnar rubber material. Further, the rubber plug 70 is a solid body. That is, the rubber plug 70 is so configured that no gap is present inside. The rubber plug 70 includes a rubber plug body portion 71, a first large-diameter portion 72, a fixing shaft portion 73, a second large-diameter portion 74 and a temporary holding shaft portion 75. The rubber plug body portion 71, the first large-diameter portion 72, the fixing shaft portion 73, the second large-diameter portion 74 and the temporary holding shaft portion 75 are provided side by side in this order from the lower side Z2 toward the upper side Z1.

The rubber plug body portion 71 is formed to be press-fittable into the communication hole 23 of the connector housing 20 with a tip part in the lead. Note that the tip part of the rubber plug body portion 71 is an end part in the downward direction Z2 of the rubber plug 70.

As shown in FIG. 4, the rubber plug body portion 71 of this embodiment includes a body shaft portion 71a and lip portions 71b pressable into contact with the communication hole 23 (see FIG. 3) by projecting radially outward from the body shaft portion 71a. The lip portion 71b is provided on the entire periphery of the body shaft portion 71a, and the entire periphery thereof can be pressed into contact with the communication hole 23. The rubber plug body portion 71 of this embodiment includes two lip portions 71b at positions separated along the third axis Z. Further, a base end part of the rubber plug body portion 71 of this embodiment includes a body diameter enlarged portion 71c having a diameter gradually increased toward the first large-diameter portion 72.

The first large-diameter portion 72 is provided on a base end part of the rubber plug body portion 71 and projects in a direction intersecting the third axis Z. A diameter of the first large-diameter portion 72 is set to be larger than that of the lip portion 71b.

As shown in FIG. 6, the first large-diameter portion 72 is provided to contact the first principal surface 65 of the cover 60 in a fixed state of the rubber plug 70 to the fixing hole 64. In particular, an end surface 72a of the first large-diameter portion 72 is set to contact the first principal surface 65 of the cover 60 in the fixed state.

The fixing shaft portion 73 extends in a direction opposite to the rubber plug body portion 71 from the first large-diameter portion 72. The fixing shaft portion 73 is provided to be fit into the fixing hole 64 in the fixed state of the rubber plug 70 to the fixing hole 64.

The second large-diameter portion 74 is provided on a tip part of the fixing shaft portion 73, is sized to be passable through the fixing hole 64 by being resiliently deformed, and projects in a direction intersecting the third axis Z. The second large-diameter portion 74 is provided to sandwich the cover 60 by the first and second large-diameter portions 72, 74 along the third axis Z in the fixed state of the rubber plug 70 to the fixing hole 64. Note that the diameter and the like of the second large-diameter portion 74 are so set that the rubber plug body portion 71 comes out from the communication hole 23 without coming out from the fixing hole 64 when the cover 60 is lifted up in the upward direction Z1 from a state where the rubber plug body portion 71 is press-fit in the communication hole 23 (see FIG. 3).

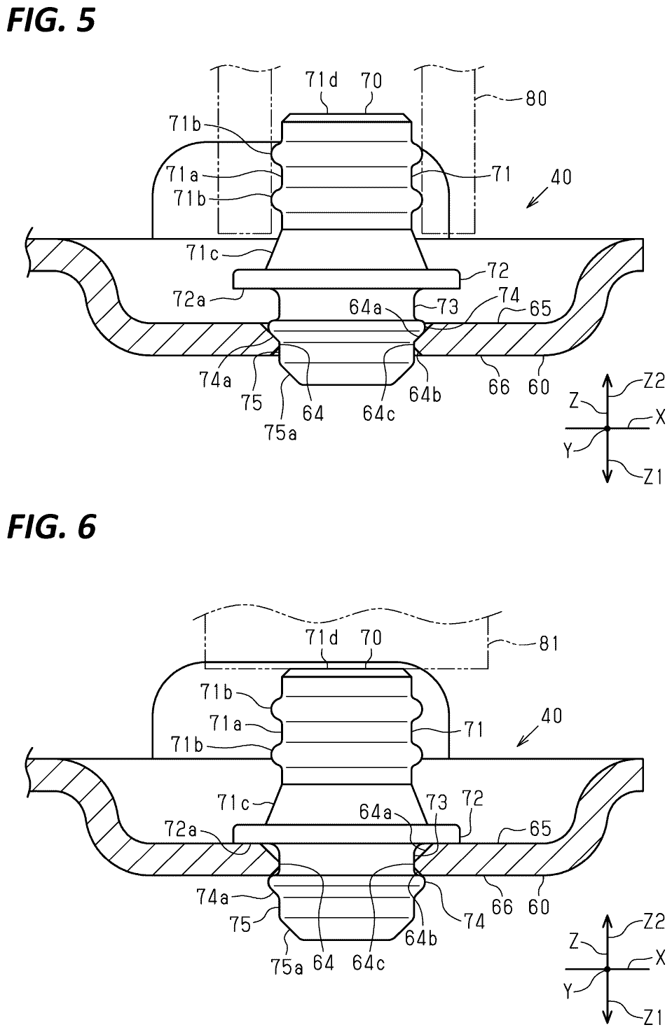

As shown in FIG. 5, the temporary holding shaft portion 75 extends in a direction opposite to the fixing shaft portion 73 from the second large-diameter portion 74. The temporary holding shaft portion 75 is provided to be able to temporarily hold the rubber plug 70 so that the rubber plug 70 is not tilted with respect to the cover 60 in a temporarily assembled state where the temporary holding shaft portion 75 is fit in the fixing hole 64. A diameter of the temporary holding shaft portion 75 of this embodiment is set to be equal to or larger than that of the body shaft portion 71a of the rubber plug body portion 71. Further, a tip part of the temporary holding shaft portion 75 includes a tapered portion 75a having a diameter gradually reduced toward a tip.

Further, the second large-diameter portion 74 of this embodiment includes an inclined portion 74a inclined to be held in surface contact with the hole diameter enlarged portion 64a of the fixing hole 64 in the temporarily assembled state where the temporary holding shaft portion 75 is fit in the fixing hole 64. That is, in this embodiment, the rubber plug 70 is supported not to be tilted with respect to the cover 60 in the temporarily assembled state by the contact of the outer peripheral surface of the temporary holding shaft portion 75 with the constant diameter portion 64c of the fixing hole 64 and the contact of the inclined portion 74a with the hole diameter enlarged portion 64a.

### (Manufacturing Process and Functions of Cover Unit 40)

The cover unit 40 configured as described above is assembled as follows.

First, as shown in FIGS. 4 and 5, the rubber plug 70 is arranged in the cover 60 having the first principal surface 65 facing in the upward direction Z1 from the upper side Z1 by a first automatic machine 80. The first automatic machine 80 is a machine configured to be able to grip the rubber plug 70 and capable of moving the gripped rubber plug 70.

As shown in FIG. 5, the first automatic machine 80 arranges the rubber plug 70 such that the temporary holding shaft portion 75 is fit into the fixing hole 64. Then, the rubber plug 70 is supported not to be tilted with respect to the cover 60 by the contact of the outer peripheral surface of the temporary holding shaft portion 75 with the constant diameter portion 64c of the fixing hole 64 and the contact of the inclined portion 74a with the hole diameter enlarged portion 64a. In other words, the rubber plug 70 stands up by the engagement of the temporary holding shaft portion 75 and the inclined portion 74a thereof with the cover 60. In this way, the rubber plug 70 is temporarily assembled.

Subsequently, as shown in FIG. 6, the rubber plug 70 is pushed in from the upper side Z1 by a second automatic machine 81. The second automatic machine 81 is a machine capable of pushing a tip surface 71d of the rubber plug body portion 71 in the downward direction Z2. If the rubber plug 70 is pushed by the second automatic machine 81, the second large-diameter portion 74 is passed through the fixing hole 64 by being resiliently deformed. Then, the rubber plug 70 is fixed to the cover 60 by fitting the fixing shaft portion 73 into the fixing hole 64 and sandwiching the cover 60 by the first and second large-diameter portions 72, 74. In this way, the rubber plug 70 is assembled.

As shown in FIG. 3, in the cover unit 40 assembled as described above, the cover 60 is fixed to the connector housing 20 and the rubber plug body portions 71 are press-fit in the communication holes 23. In this way, the intrusion of a liquid into the connector housing 20 through the communication holes 23 is prevented.

Further, the cover unit 40 is removed from the connector housing 20 at the time of voltage detection for the terminal fittings 50. A probe of an unillustrated voltage detector is brought into contact with the terminal fitting 50 through the communication hole 23, whereby voltage detection from the outside of the connector 10 is performed for the terminal fitting 50.

### Effects of Embodiment

Next, effects of the above embodiment are described below.
(1) The rubber plug 70 is fixed to the cover 60 by fitting the fitting shaft portion 73 into the fixing hole 64 and sandwiching the cover 60 by the first and second large-diameter portions 72, 74 if the second large-diameter portion 74 is passed through the fixing hole 64. Thus, the configuration can be, for example, simpler than a configuration provided with a separate rubber plug holder for fixing the rubber plug 70 to the cover 60. Further, the rubber plug 70 includes the temporary holding shaft portion 75 extending in the direction opposite to the fixing shaft portion 73 from the second large-diameter portion 74. Since the temporary holding shaft portion 75 can temporarily hold the rubber plug 70 so that the rubber plug 70 is not tilted with respect to the cover 60 in the temporarily assembled state where the temporary holding shaft portion 75 is fit in the fixing hole 64, assemblability with the cover 60 is improved. For example, the rubber plug 70 can be easily assembled with the cover 60 by the first automatic machine 80 for arranging the rubber plug 70 to fit the temporary holding shaft portion 75 into the fixing hole 64 and the second automatic machine 81 for assembling the rubber plug 70 by pushing the rubber plug 70 from the temporarily assembled state.
(2) Since the fixing hole 64 includes the hole diameter enlarged portion 64a having a diameter gradually increased toward the first principal surface 65, the temporary holding shaft portion 75 of the rubber plug 70 is easily fit. Since the second large-diameter portion 74 includes the inclined portion 74a inclined to be held in surface contact with the hole diameter enlarged portion 64a of the fixing hole 64 in the temporarily assembled state where the temporary holding shaft portion 75 is fit in the fixing hole 64, the rubber plug 70 is hardly tilted with respect to the cover 60 in the temporarily assembled state. Therefore, the assemblability of the rubber plug 70 with the cover 60 is improved.
(3) The base end part of the rubber plug body portion 71 includes the body diameter enlarged portion 71c having a diameter gradually increased toward the first large-diameter portion 72. Thus, it can be suppressed that the rubber plug 70 is bent with respect to the third axis Z, for example, when the rubber plug 70 is pushed from the temporarily assembled state where the temporary holding shaft portion 75 is fit in the fixing hole 64.
(4) Since the diameter of the temporary holding shaft portion 75 is set to be equal to or larger than that of the body shaft portion 71a of the rubber plug body portion 71, the rubber plug 70 is less likely to be tilted with respect to the cover 60 in the temporarily assembled state, for example, as compared to the case where the diameter of the temporary holding shaft portion 75 is set to be smaller than that of the body shaft portion 71a.
(5) Since the rubber plug 70 is a solid body, it can be suppressed that the rubber plug 70 is bent with respect to the third axis Z, for example, when the rubber plug 70 is pushed from the temporarily assembled state where the temporary holding shaft portion 75 is fit in the fixing hole 64. That is, if the rubber plug 70 is, for example, configured to have a gap inside, the rubber plug 70 is easily bent when the rubber plug 70 is pushed from the temporarily assembled state where the temporary holding shaft portion 75 is fit in the fixing hole 64. However, if the rubber plug 70 is a solid body, this can be suppressed.

### (Modifications)

The above embodiment can be modified and carried out as follows. The above embodiment and the following modifications can be carried out in combination without technically contradicting each other.
Although the fixing hole 64 includes the hole diameter enlarged portion 64a having a diameter gradually increased toward the first principal surface 65 in the above embodiment, there is no limitation to this and, for example, the hole diameter enlarged portion 64a may not be provided. Note that, in this case, the second large-diameter portion 74 preferably does not include the inclined portion 74a. Further, even if the fixing hole 64 includes the hole diameter enlarged portion 64a, the second large-diameter portion 74 may not include the inclined portion 74a.
Although the base end part of the rubber plug body portion 71 includes the body diameter enlarged portion 71c having a diameter gradually increased toward the first large-diameter portion 72 in the above embodiment, there is no limitation to this and the body diameter enlarged portion 71c may not be provided.
Although the diameter of the temporary holding shaft portion 75 is set to be equal to or larger than that of the body shaft portion 71a of the rubber plug body portion 71 in the above embodiment, there is no limitation to this and, for example, the diameter of the temporary holding shaft portion 75 may be set to be smaller than that of the body shaft portion 71a.
Although the rubber plug 70 is a solid body in the above embodiment, there is no limitation to this and, for example, the rubber plug 70 may have a gap inside. Further, the rubber plug 70 may be, for example, configured such that another member such as a resin member is embedded inside.
Although the connector housing 20 includes the two communication holes 23 in the above embodiment, there is no limitation to this and, for example, the number of the communication holes 23 may be changed to one, three or more. Note that, of course, the number of the rubber plugs 70 of the cover unit 40 also needs to be changed in this case.
The embodiment disclosed this time is illustrative in all aspects, and the present invention is not limited to these illustrations. That is, the scope of the present invention is represented by claims and intended to include all changes in the scope of claims and in the meaning and scope of equivalents.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A cover unit, comprising:
a columnar rubber plug press-fittable into a communication hole of a connector housing along a press-fit axis; and
a plate-like cover including a fixing hole for fixing the rubber plug, the cover being fixable to the connector housing,
the rubber plug including:
a rubber plug body portion press-fittable into the communication hole with a tip part in the lead;
a first large-diameter portion provided on a base end part of the rubber plug body portion, the first large-diameter portion projecting in a direction intersecting the press-fit axis, the first large-diameter portion contacting a first principal surface of the cover in an assembled state where the rubber plug is assembled in the fixing hole;
a fixing shaft portion extending in a direction opposite to the rubber plug body portion from the first large-diameter portion, the fixing shaft portion being fit in the fixing hole in the assembled state;
a second large-diameter portion provided on a tip part of the fixing shaft portion, the second large-diameter portion projecting in a direction intersecting the press-fit axis while being sized to be passable through the fixing hole by being resiliently deformed, the cover being sandwiched along the press-fit axis by the first large-diameter portion and the second large-diameter portion in the assembled state; and
a temporary holding shaft portion extending in a direction opposite to the fixing shaft portion from the second large-diameter portion, the temporary holding shaft portion being capable of temporarily holding the rubber plug so that the rubber plug is not tilted with respect to the cover in a temporarily assembled state where the temporary holding shaft portion is fit in the fixing hole.

2. The cover unit of claim 1, wherein:
the fixing hole includes a hole diameter enlarged portion having a diameter gradually increased toward the first principal surface, and
the second large-diameter portion includes an inclined portion inclined to be held in surface contact with the hole diameter enlarged portion in the temporarily assembled state.

3. The cover unit of claim 1, wherein the base end part of the rubber plug body portion includes a body diameter enlarged portion having a diameter gradually increased toward the first large-diameter portion.

4. The cover unit of claim 1, wherein:
the rubber plug body portion includes a body shaft portion and a lip portion pressable into contact with the communication hole by projecting radially outward from the body shaft portion, and
a diameter of the temporary holding shaft portion is set to be equal to or larger than that of the body shaft portion.

5. The cover unit of claim 1, wherein the rubber plug is a solid body.

6. A connector, comprising:
the cover unit of claim 1;
the connector housing; and
a terminal fitting accommodated inside the connector housing, voltage detection from outside through the communication hole being enabled for the terminal fitting.
